(19) United States
(12) Patent Application Publication
(10) Pub. No.: US 2017/0334157 A1
(43) Pub. Date: Nov. 23, 2017

(54) PNEUMATIC TIRE

(71) Applicant: SUMITOMO RUBBER INDUSTRIES, LTD., Kobe-shi (JP)

(72) Inventors: Shinichiro HONDA, Kobe-shi (JP); Daiki MUKOUGUCHI, Kobe-shi (JP); Takuma YOSHIZUMI, Kobe-shi (JP)

(73) Assignee: SUMITOMO RUBBER INDUSTRIES, LTD., Kobe-shi (JP)

(21) Appl. No.: 15/601,038

(22) Filed: May 22, 2017

(30) Foreign Application Priority Data
May 23, 2016 (JP) 2016-102352

(51) Int. Cl. B29D 30/00; B29C 45/26; C08K 3/00; C08K 3/04

(52) U.S. Cl. CPC B29D 30/0005; B29C 45/2669; C08K 3/0016; C08K 3/04; C08K 3/0033

(57) ABSTRACT

A pneumatic tire includes an inner liner including a vulcanized rubber composition such that a number of voids each having a volume of 4.19 μm³ or more per 8,000,000 μm³ in the vulcanized rubber composition is 2 or less in an environment of 60° C. under an atmospheric pressure, and that the vulcanized rubber composition has an air permeation coefficient of 0.95×10⁻¹⁰ cm³·cm/(cm²·s·cmHg) or less when measured using a differential pressure method in the environment of 60° C.

### CROSS-REFERENCE TO RELATED APPLICATIONS

The present application is based upon and claims the benefit of priority to Japanese Patent Application No. 2016-102352, filed May 23, 2016, the entire contents of which are incorporated herein by reference.

### BACKGROUND OF THE INVENTION

### Field of the Invention

The present invention relates to a pneumatic tire.

### Description of Background Art

Japanese Patent Laid-Open Publication No. 2014-227494 describes a pneumatic tire. The entire contents of this publication are incorporated herein by reference.

### SUMMARY OF THE INVENTION

According to one aspect of the present invention, a pneumatic tire includes an inner liner including a vulcanized rubber composition such that a number of voids each having a volume of 4.19 μm³ or more per 8,000,000 μm³ in the vulcanized rubber composition is 2 or less in an environment of 60° C. under an atmospheric pressure, and that the vulcanized rubber composition has an air permeation coefficient of 0.95×10⁻¹⁰ cm³·cm/(cm²·s·cmHg) or less when measured using a differential pressure method in the environment of 60° C.

According to another aspect of the present invention, a method for manufacturing a vulcanized rubber composition includes extrusion-molding an unvulcanized rubber composition by an extruder including a screw having a slit such that the unvulcanized rubber passes through the slit having a maximum width of 2 mm or less and degassed during the extrusion-molding of the unvulcanized rubber composition, and vulcanizing the unvulcanized rubber composition within 24 hours after the extrusion-molding of the unvulcanized rubber composition such that a vulcanized rubber composition is obtained. A number of voids each having a volume of 4.19 μm³ or more per 8,000,000 μm³ in the vulcanized rubber composition is 2 or less in an environment of 60° C. under an atmospheric pressure, and the vulcanized rubber composition has an air permeation coefficient of 0.95×10⁻¹⁰ cm³·cm/(cm²·s·cmHg) or less when measured using a differential pressure method in the environment of 60° C.

### DETAILED DESCRIPTION OF THE EMBODIMENTS

Embodiments will now be described.

### Pneumatic Tire

A pneumatic tire according to an embodiment of the present invention includes an inner liner formed of a vulcanized rubber composition. A number of voids each having a volume of 4.19 μm³ or more per 8,000,000 μm³ in the vulcanized rubber composition in an environment of 60° C. under an atmospheric pressure is 2 or less. An air permeation coefficient of the vulcanized rubber composition measured using a differential pressure method in an environment of 60° C. is 0.95×10⁻¹⁰ cm³·cm/(cm²·s·cmHg) or less. In an embodiment of the present invention, the pneumatic tire has excellent low gas permeability when the number of the voids in the specific volume is 2 or less, and the air permeation coefficient is 0.95×10⁻¹⁰ cm³·cm/ (cm²·s·cmHg) or less. In the following, a pneumatic tire according to an embodiment of the present invention is described in detail.

In an embodiment of the present invention, the number of the voids is a value obtained by measuring a number of voids each having a volume of 4.19 μm³ or more per 8,000,000 μm³ or more in an image obtained by cutting the vulcanized rubber composition in a thickness direction and observing the resulting cross section of the vulcanized rubber composition using a scanning electron microscopy (in an observation visual field of 1000 times to 3000 times) in an environment of 60° C. under an atmospheric pressure. Further, the volume of each void is a value obtained based on a maximum length of the void in the image of the cross section and assuming that the void is a sphere.

In an embodiment of the present invention, it is confirmed from an electron microscopic photograph or the like that voids each having a volume of 4.19 μm³ or more are primarily due to fine foaming around solid fine particles (in particular, zinc oxide particles) contained in the vulcanized rubber composition. In an embodiment of the present invention, it is found that, by setting the number of the voids to 2 or less, the pneumatic tire has an excellent low gas permeability.

Further, in an embodiment of the present invention, the air permeation coefficient (cc·cm/cm²·sec·cmHg) is a value measured using a differential pressure method, according to a method specified in JIS K6275-1, and using a gas permeability measuring device “G2700” manufactured by Yanaco Analytical Systems Inc., in an environment in which a test gas is air and a test temperature is 60° C.

In an embodiment of the present invention, a composition of the vulcanized rubber composition is not particularly limited as long as the composition can be used for an inner liner of a pneumatic tire. However, it is preferable that the composition contain a butyl-based rubber.

Examples of butyl-based rubbers include a brominated butyl rubber (Br-IIR), a halogenated butyl rubber (X-IIR) such as a chlorinated butyl rubber (Cl-IIR), a butyl rubber (IIR), and the like, and Cl-IIR and IIR are particularly preferable. These butyl-based rubbers may each be independently used, or two or more of these butyl-based rubbers may be used in combination.

A blending amount of a butyl-based rubber in the vulcanized rubber composition is not particularly limited. However, from a point of view of suppressing formation of a large number of large voids (each having a volume of 4.19 μm³ or more) while effectively reducing the gas permeability of the vulcanized rubber composition, the blending amount of the butyl-based rubber is preferably 80 parts by mass or more, more preferably about 80-100 parts by mass, and even more preferably about 85-100 parts by mass.

Further, in an embodiment of the present invention, in addition to the butyl-based rubber, the vulcanized rubber composition may further contain a natural rubber, a carbon black, filler, a compatibilizing agent, and the like.

The natural rubber is not particularly limited. Specific examples of the natural rubber include those used in the tire industry such as SIR20, RSS#3, TSR20. Further, as the natural rubber, an epoxidized natural rubber or the like may also be used. These natural rubbers may each be independently used, or two or more of these natural rubbers may be used in combination.

A blending amount of a natural rubber in the vulcanized rubber composition is not particularly limited. However, from a point of view of suppressing formation of large voids while effectively reducing the gas permeability of the vulcanized rubber composition, the blending amount of the natural rubber is preferably 20 parts by mass or less, more preferably about 0-20 parts by mass, and even more preferably about 0-15 parts by mass.

The carbon black is not particularly limited, and a carbon black blended in a vulcanized rubber composition can be used. Specific examples of carbon blacks include SAF, ISAF, HAF, FF, FEF, GPF and the like that are used in the tire industry.

The carbon black contained in the vulcanized rubber composition is preferably dehydrated (dehydrated before being blended into an unvulcanized rubber composition before vulcanization). In an embodiment of the present invention, by dehydrating the carbon black before vulcanization, an increase in water content in the unvulcanized rubber composition can be effectively suppressed. Therefore, when the unvulcanized rubber composition is exposed to a high temperature environment until a vulcanized rubber composition is obtained, formation of large voids due to vaporization of water is effectively suppressed. Therefore, it is possible to effectively suppress formation of large voids while reducing the gas permeability of the vulcanized rubber composition. The dehydration of the carbon black can be performed, for example, by heating the carbon black in an oven at 120° C. or higher for two days or more, or by drying the carbon black in a vacuum oven, or the like. Carbon blacks may each be independently used, or two or more carbon blacks may be used in combination.

A water content of the carbon black is preferably 0.5 mass % or less, and more preferably 0.3 mass % or less. For example, when the carbon black has a particle size larger than an FEF class, the water content of the carbon black is preferably 0.3 mass % or less, and when the carbon black has a particle size smaller than the FEF class, the water content of the carbon black is preferably 0.5 mass % or less. The water content of the carbon black is a value measured according to heating loss of JIS K6218.

A nitrogen adsorption specific surface area (N₂SA) of the carbon black is preferably 20 m²/g or more, and more preferably 30 m²/g or more. When the N₂SA of the carbon black is less than 20 m²/g, there is a tendency that a sufficient reinforcing property cannot be obtained. Further, the N₂SA of the carbon black is preferably 80 m²/g or less, and more preferably 50 m²/g or less. When the N₂SA of the carbon black exceeds 80 m²/g, there is a tendency that heat generation increases and low fuel consumption performance decreases. The N₂SA of the carbon black in the present invention is a value obtained according to Method A of JIS K6217.

From a point of view that a sufficient reinforcing property can be obtained, dibutyl phthalate oil absorption (DBP) of the carbon black is preferably 70 ml/(100 g) or more, and more preferably 90 ml/(100 g) or more. Further, from a point of view that an excellent fatigue resistance property, such as elongation at break, can be obtained, the DBP of the carbon black is preferably 150 ml/(100 g) or less, and more preferably 130 ml/(100 g) or less. The DBP of the carbon black is a value obtained according to a measurement method of JIS K6217-4.

A blending amount of the carbon black in the vulcanized rubber composition is not particularly limited. However, from a point of view of suppressing formation of large voids while effectively reducing the gas permeability of the vulcanized rubber composition, the blending amount of the carbon black is preferably 40 parts by mass or more, more preferably about 45-70 parts by mass, and even more preferably about 48-60 parts by mass.

The filler is not particularly limited. Either an organic filler or an inorganic filler may be contained. Specific examples of the filler include zinc oxide, silica, calcium carbonate, mica, aluminum hydroxide, magnesium hydroxide, magnesium oxide, clay, talc, titanium oxide, carbon fiber, cellulose fiber, carbon nanotube (multilayer, single layer), graphene, and the like. Among these fillers, from a point of view that a vulcanization reaction of the unvulcanized rubber composition is effectively promoted, zinc oxide is preferably contained.

It is preferred that at least one of the fillers contained in the vulcanized rubber composition is dehydrated (dehydrated before being blended into an unvulcanized rubber composition before vulcanization). In an embodiment of the present invention, by dehydrating the filler, an increase in the water content in the unvulcanized rubber composition can be effectively suppressed. Therefore, when the unvulcanized rubber composition is exposed to a high temperature environment until a vulcanized rubber composition is obtained, formation of large voids due to vaporization of water is effectively suppressed. Therefore, it is possible to more effectively suppress formation of large voids while reducing the gas permeability of the vulcanized rubber composition. Dehydration of the filler can be performed, for example, using a vacuum drying oven or the like. Fillers may each be independently used, or two or more fillers may be used in combination. A water content in a filler is preferably 0.5 mass % or less, and more preferably 0.3 mass % or less. The water content in the filler can be measured according to heating loss of JIS K 6218, according to a Karl Fischer water content measurement method, or the like.

A blending amount of the filler in the vulcanized rubber composition is not particularly limited. However, from a point of view of promoting vulcanization of the vulcanized rubber composition, the blending amount of the filler is preferably 1 part by mass or more, more preferably about 1.2-6 parts by mass, and even more preferably about 1.5-5 parts by mass.

The compatibilizing agent is not particularly limited, and those used in the rubber industry can be used. A compatibilizing agent preferably has a property of reducing separation energy at an interface between a polymer and filler or between different polymers and promoting mixing between the polymer and the filler or between the different polymers. Specific examples of compatibilizing agents include non-reactive compatibilizing agents such as a styrene-ethylene-butadiene block copolymer, a styrene-methyl methacrylate block copolymer, an ethylene-styrene graft copolymer, chlorinated polyethylene, a mixture of an aromatic hydrocarbon resin and an aliphatic hydrocarbon resin, and a metal soap of an unsaturated fatty acid, and reactive compatibilizing agents such as maleic anhydride grafted polypropylene, a styrene-maleic anhydride copolymer, an ethylene-glycidyl methacrylate copolymer, an ethylene-glycidyl methacrylate copolymer, and a styrene graft copolymer. The compatibilizing agents may each be independently used, or two or more of the compatibilizing agents may be used in combination.

A blending amount of the compatibilizing agent in the vulcanized rubber composition is not particularly limited. However, from a point of view of suppressing formation of large voids while effectively reducing the gas permeability of the vulcanized rubber composition, the blending amount of the compatibilizing agent is preferably 5 parts by mass or more, more preferably about 5-15 parts by mass, and even more preferably about 5-10 parts by mass.

In addition to the above components, compounding agents that are used in the rubber industry, for example, thermoplastic polyurethane, a stearic acid, an anti-aging agent, oil, wax, a vulcanization agent such as sulfur, a vulcanization accelerator, and the like, can be appropriately blended into the vulcanized rubber composition.

Examples of the vulcanization accelerator include N-tert-butyl-2-benzothiazolylsulfenamide (TBBS), N-cyclohexyl-2-benzothiazolylsulfenamide (CBS), N,N′-dicyclohexyl-2-benzothiazolylsulfenamide (DZ), mercaptobenzothiazole (MBT), dibenzothiazolyl disulfide (MBTS), diphenylguanidine (DPG), and the like. Among these vulcanization accelerators, for a reason of having an excellent vulcanization property and having a large effect in improving mechanical strength in physical properties of a rubber after vulcanization, sulfenamide-based vulcanization accelerators such as TBBS, CBS and DZ and thiazole-based vulcanization accelerators such as MBT and MBTS are preferable.

The vulcanized rubber composition, for example, is preferably degassed by passing through a slit having a maximum width of 2 mm or less provided in a screw of an extruder during extrusion molding of the unvulcanized rubber composition, which contains the above-described butyl-based rubber, natural rubber, carbon black, filler, compatibilizing agent and the like (excluding a vulcanization agent). More specifically, when the components that form the unvulcanized rubber composition are kneaded using a Banbury mixer, extruder or the like, it is preferable that the components are caused to pass through slits (multiple slits may be provided in a screw) each having a maximum width of 2 mm or less provided in a screw of an extruder, and further, degassing is performed from a degassing hole provided immediately after the slits. When degassing is performed in such a specific process in the vulcanized rubber composition that forms the inner liner of a pneumatic tire according to an embodiment of the present invention, gas and water contained in the unvulcanized rubber composition are effectively removed, and formation of large voids is further effectively suppressed while the gas permeability of the vulcanized rubber composition is more effectively reduced.

A shape of each slit provided in the screw is not particularly limited. Each slit, for example, is preferably provided as a hole having a circular cross section in the screw. The number of slits is not particularly limited, and may be appropriately set.

A kneading temperature before the unvulcanized rubber composition is degassed (that is, a temperature before the unvulcanized rubber composition passes through the slits) is not particularly limited. However, from a point of view of homogeneously mixing the components, the kneading temperature is preferably about 75-95° C.

Further, in an embodiment of the present invention, from a point of view of suppressing formation of large voids while effectively suppressing the gas permeability of the vulcanized rubber composition, in particular, with respect to the unvulcanized rubber composition after degassing has been performed, it is preferable to add zinc oxide, a vulcanization agent, a vulcanization accelerator and the like at a temperature of about 75-95° C. and to perform kneading. That is, in an embodiment of the present invention, it is preferable to use dehydrated zinc oxide as filler and add the zinc oxide under such a predetermined timing and temperature. As a result, formation of large voids due to vaporization of water contained in the unvulcanized rubber composition at a high temperature during kneading can be effectively suppressed. Further, by suppressing formation of such large voids, the resulting vulcanized rubber composition can have particularly excellent low-gas permeability.

In the vulcanized rubber composition, the above-described heat history during extrusion molding is preferably 100° C. or more, and a discharge temperature is preferably 100-130° C. When such a temperature is reached during discharge, the components are homogeneously dispersed, and the rubber is sufficiently fluidized and thus can be easily molded into any shape. When the temperature of the unvulcanized rubber composition becomes high, there is a problem that water and volatile components contained in the unvulcanized rubber composition evaporate and large voids are likely to form in the vulcanized rubber composition. However, according to an embodiment of the present invention, dehydrated filler is used and the above-described degassing is performed during extrusion, and further, vulcanization is performed within 24 hours after the unvulcanized rubber is extrusion-molded. Therefore, gases and water contained in the unvulcanized rubber composition are effectively removed. Even when the temperature during extrusion molding reaches or exceeds a volatilization temperature (100° C.) of water, which is a typical volatile component, foaming due to volatilization of water can be suppressed, and along with this, the gas permeability can be reduced. Further, from a point of view of suppressing formation of large voids while effectively reducing the gas permeability of the vulcanized rubber composition, during the above-described extrusion molding, the heating temperature when the unvulcanized rubber composition passes through the slits is preferably 100° C. or more. As a result, water and the like can be efficiently removed by degassing immediately after the unvulcanized rubber composition passes through the slits.

Further, the vulcanized rubber composition is preferably vulcanized within 24 hours after the unvulcanized rubber composition is extrusion-molded. In an embodiment of the present invention, when vulcanization is performed within such a short period of time, an increase in gases and water in the unvulcanized rubber composition to be vulcanized (adsorption of water and the like from an external environment when the unvulcanized rubber composition is left unvulcanized) is effectively suppressed. Therefore, formation of large voids due to vaporization of water or the like at a high temperature during vulcanization is effectively suppressed, and it is possible to suppress the formation of large voids while effectively reducing the gas permeability of the vulcanized rubber composition.

Vulcanization of the unvulcanized rubber composition can be performed. For example, the vulcanization can be performed by applying heat and pressure, at a temperature of 138-191° C., to the unvulcanized rubber composition in which a vulcanization agent, a vulcanization accelerator and the like are blended. For example, when the vulcanized rubber composition is used for an inner liner part of a tire, the unvulcanized rubber composition is extrusion-molded into a shape of an inner liner, is laminated together with other tire members on a tire molding machine, and a tire using the unvulcanized rubber composition is formed. By applying heat and pressure to the unvulcanized tire in a vulcanizer, a pneumatic tire in which the vulcanized rubber composition is used for the inner liner part can be manufactured.

A number of voids each having a volume of 4.19 μm³ or more per 8,000,000 μm³ in the vulcanized rubber composition in an environment of 60° C. under an atmospheric pressure is 2 or less. Further, an air permeation coefficient of the vulcanized rubber composition measured using a differential pressure method in an environment of 60° C. is 0.95×10⁻¹⁰ cm³·cm/(cm²·s·cmHg) or less. Therefore, the gas permeability of the vulcanized rubber composition is effectively reduced. In an embodiment of the present invention, a method for measuring the number of voids in the rubber composition after vulcanization and a method for measuring the air permeation coefficient are respectively as described above. However, more specifically, the number of voids and the air permeation coefficient are respectively values measured using methods described in Examples.

From a point of view of allowing a low gas permeability of the vulcanized rubber composition to be achieved, a thickness of a thinnest portion is preferably 0.2 mm or more. When the thickness of the thinnest portion is 0.2 mm or more, during a storage period until the unvulcanized rubber composition is vulcanized to become the vulcanized rubber composition, absorption of moisture in the air, which causes formation of large voids, can be suppressed, and it is possible to suppress the formation of large voids while effectively reducing the gas permeability of the vulcanized rubber composition.

A pneumatic tire according to an embodiment of the present invention includes an inner liner that forms a tire cavity surface, and the vulcanized rubber composition forms the inner liner. The inner liner is a member positioned to hold a tire internal pressure by reducing an amount of air permeation from the tire cavity. A pneumatic tire according to an embodiment of the present invention can be suitably used as a passenger car tire, a truck/bus tire, a motorcycle tire, and the like.

### Method for Manufacturing Vulcanized Rubber Composition

A method for manufacturing the vulcanized rubber composition used for the inner liner of a pneumatic tire according to an embodiment of the present invention is not particularly limited. However, the vulcanized rubber composition is suitably manufactured, for example, using the following method for manufacturing the vulcanized rubber composition according to an embodiment of the present invention.

That is, a method for manufacturing a vulcanized rubber composition according to an embodiment of the present invention includes a kneading process in which an unvulcanized rubber composition is subjected to kneading by extrusion molding, and a vulcanization process in which, after the kneading process, the unvulcanized rubber composition is vulcanized. In the kneading process, the unvulcanized rubber composition is degassed after (preferably immediately after) passing through a slit having a maximum width of 2 mm or less provided in a screw of the extruder. In the vulcanization process, the unvulcanized rubber composition is vulcanized within 24 hours after being extrusion-molded in the kneading process. In the method for manufacturing the vulcanized rubber composition according to an embodiment of the present invention, by having such a specific process, it is possible to suppress the formation of large voids while effectively reducing the gas permeability of the vulcanized rubber composition.

In a method for manufacturing the vulcanized rubber composition according to an embodiment of the present invention, the types and amounts of the components that form the vulcanized rubber composition are as described above. Further, from the preparation of the unvulcanized rubber composition to the vulcanization process, such as the kneading process in which, during kneading using an extruder, the unvulcanized rubber composition is degassed after passing through a slit having a maximum width of 2 mm or less provided in a screw of the extruder, are also as described above.

### EXAMPLES

In the following, examples of the present invention are described. However, the present invention is not limited to the following examples.

Details of materials used in the examples are as follows.

Chlorobutyl rubber: 1066 manufactured by Exxon Chemical Co., Ltd.

Natural rubber: RSS #3

Carbon black: Obtained by dehydrating GPF (having a nitrogen adsorption specific surface area of 28 m²/g) (manufactured by Mitsubishi Chemical Corporation) by storing the GPF in an oven at 120° C.

Compatibilizing agent: Promix 400 manufactured by Flow Polymers Inc.

Paraffin process oil: PS-32 manufactured by Idemitsu Kosan Co., Ltd.

Anti-aging agent: Nocrac 6C manufactured by Ouchi Shinko Chemical Industry Co., Ltd.

Stearic acid: Bead stearic acid camellia manufactured by NOF Corporation

Zinc dehydroxide: Obtained by drying zinc oxides (two kinds) (manufactured by Mitsui Mining & Smelting Co., Ltd.) in a vacuum drying oven at 30° C. for 24 hours

Undehydrated zinc oxide: Zinc oxides (two kinds) manufactured by Mitsui Mining & Smelting Co., Ltd.

Powdered sulfur: manufactured by Tsurumi Chemical Industry Co., Ltd.

Vulcanization accelerator (A): Nocceler M-P manufactured by Ouchi Shinko Chemical Industrial Co., Ltd.

Vulcanization accelerator (B): Nocceler DM-P manufactured by Ouchi Shinko Chemical Industrial Co., Ltd.

### Example 1

Components at mixing ratios shown in Table 1 are kneaded using a 1.7 L Banbury mixer. As kneading conditions, F.F. is 58%, a rotation speed is 100 rpm, and a temperature is 160° C. Next, an unvulcanized rubber composition obtained by the kneading is subjected to extrusion molding using an extruder (60φ vent extruder, manufactured by Nakada Engineering Co., Ltd.). A slit having a maximum width of 2 mm is provided in a screw of the extruder, and it is designed such that the unvulcanized rubber composition passes through the slit. Further, immediately after the slit, a degassing hole is provided and the unvulcanized rubber composition is degassed by sucking a gas from the degassing hole. The powdered sulfur and the vulcanization accelerators (A, B) are added to the degassed unvulcanized rubber composition, and the resulting mixture is further kneaded at 95° C. and is discharged from a die so as to have a sheet-like shape having a thickness of 2 mm. After being discharged from the die, the unvulcanized rubber composition is stored for 8 hours at a room temperature in the atmosphere until being subjected to vulcanization. Next, the obtained sheet-like unvulcanized rubber composition is cut into predetermined dimensions and is vulcanized using the powder sulfur and the vulcanization accelerators (A, B) at 170° C. for 12 minutes to obtain a sheet-like vulcanized rubber composition.

### Example 2

A sheet-like vulcanized rubber composition is obtained in the same manner as in Example 1 except that the dehydrated zinc oxide is used instead of the undehydrated zinc oxide.

### Comparative Example 1

A sheet-like vulcanized rubber composition is obtained in the same manner as in Example 1 except that the unvulcanized rubber composition is not degassed and the unvulcanized rubber composition is stored for 30 hours.

### Comparative Example 2

A sheet-like vulcanized rubber composition is obtained in the same manner as in Comparative Example 1 except that the dehydrated zinc oxide is used instead of the undehydrated zinc oxide.

### Comparative Example 3

A sheet-like vulcanized rubber composition is obtained in the same manner as in Example 1 except that the unvulcanized rubber composition is stored for 30 hours.

### Comparative Example 4

A sheet-like vulcanized rubber composition is obtained in the same manner as in Example 1 except that the unvulcanized rubber composition is not degassed.

### Comparative Example 5

A sheet-like vulcanized rubber composition is obtained in the same manner as in Example 1 except that, instead of the slit having a maximum width of 2 mm, a slit having a maximum width of 5 mm is provided in the screw of the extruder and it is designed such that the unvulcanized rubber composition passes through the slit.

### Evaluation of Gas Permeability

The gas permeability of each of the vulcanized rubber compositions obtained above is evaluated. In the evaluation of the gas permeability, an air permeation coefficient (cc·cm/cm²·sec·cmHg) is measured according to a method specified in JIS K6275-1 using a gas permeability measurement apparatus “G2700” (manufactured by Yanaco Co., Ltd.) under conditions in which a test gas is air and a test temperature is 60° C. The results are shown in Table 1.

### Evaluation of Void Volume

Each of the vulcanized rubber compositions obtained above is cut in a thickness direction, and the resulting cross section is observed using a scanning electron microscopy (in an observation visual field of 1000 times to 3000 times) and the number of voids each having a volume of 4.19 μm³ or more per 8,000,000 μm³ in the each of the vulcanized rubber compositions is confirmed. The volume of each void is a value obtained based on a maximum length of the void in an image of the cross section observed using the scanning electron microscopy and assuming that the void is a sphere. The results are shown in Table 1. With respect to the vulcanized rubber composition discharged from the extruder in a state in which a temperature during the discharge became constant, the volume of each void is evaluated. A sampling range is at a central portion of the sheet-like vulcanized rubber composition, and 12 places are observed with intervals between the places so to avoid overlapping between observation fields. Further, the central portion of the sheet-like vulcanized rubber composition is a portion where voids are most likely to form. Therefore, in the vulcanized rubber composition, for example, when the number of voids each having a volume of 4.19 μm³ or more is 2 or less, at a constant discharge temperature, it can be evaluated that the number of voids is 2 or less also in subsequently obtained sheet-like vulcanized rubber composition.

### Air Leakage Test

First, in the same way for each of the Example 1 and 2 and Comparative Example 1-5, a polymer sheet for an inner liner layer is obtained formed from a sheet-like unvulcanized rubber composition having a thickness of 0.05 mm. On the other hand, using a T-die extruder, a chlorobutyl rubber (“Exxon chlorobutyl 1068” manufactured by Exxon Mobil Corporation) as a rubber component and other compounding agents are kneaded, and a rubber composition for a rubber layer is obtained. In this case, a profile is attached to an extrusion port of the T-die extruder so that a thickness of a region corresponding to a tread part (a thickness in a cross section in a tire meridian direction when the tire is filled with air at a specified internal pressure after vulcanization) is 1.0 mm and a thickness of all other regions is 0.5 mm. Next, a raw tire is manufactured by using the polymer sheet as an inner liner layer and positioning the rubber layer on a tire radial direction inner side. Next, in a vulcanization process, the raw tire is press-molded at 170° C. for 20 minutes, and a pneumatic tire having a size of 195/65R15 is manufactured. For structures other than the above-described inner liner layer and rubber layer, materials that are used for manufacturing a tire may be used. Next, the obtained pneumatic tire is mounted to a rim (22.5×7.50) and is stored for 3 months with an initial pressure of 200 kPa at a room temperature of 21° C. in a no-load state. During this period, the internal pressure is measured every 4 days. A regression coefficient (a) is calculated based on the following Formula (1) where P0 (kPa) is the initial pressure, Pt (kPa) is the measured pressure, and t (days) is the elapsed time. From the obtained regression coefficient (α), air leakage per month (β) (%/month) is calculated based on the following Formula (2), where t=30 days. The obtained values of air leakage (β) (%/month) of Example 1 and 2 and Comparative Example 1-5 are shown in Table 1 with the value of Comparative Example 2 as 1.00 (reference).

Pt/P0=exp(−αt) (1)

β=(1−exp(−αt))×100 (2)

TABLE 1

| | | Comparative | Comparative | Comparative | Comparative | Comparative | | |
|---|---|---|---|---|---|---|---|---|
| | | Example 1 | Example 2 | Example 3 | Example 4 | Example 5 | Example 1 | Example 2 |
| Composition | Chlorobutyl rubber | 95 | 95 | 95 | 95 | 95 | 95 | 95 |
| (parts by | Natural rubber | 5 | 5 | 5 | 5 | 5 | 5 | 5 |
| mass) | Carbon black | 55 | 55 | 55 | 55 | 55 | 55 | 55 |
| | Compatibilizing agent | 5 | 5 | 5 | 5 | 5 | 5 | 5 |
| | Process oil | 2 | 2 | 2 | 2 | 2 | 2 | 2 |
| | Anti-aging agent | 2 | 2 | 2 | 2 | 2 | 2 | 2 |
| | Stearic acid | 1.5 | 1.5 | 1.5 | 1.5 | 1.5 | 1.5 | 1.5 |
| | Undehydrated zinc oxide | 1.5 | | 1.5 | 1.5 | 1.5 | 1.5 | |
| | Zinc dehydroxide | | 1.5 | | | | | 1.5 |
| | Powdered sulfur | 0.5 | 0.5 | 0.5 | 0.5 | 0.5 | 0.5 | 0.5 |
| | Vulcanization | 0.5 | 0.5 | 0.5 | 0.5 | 0.5 | 0.5 | 0.5 |
| | accelerator | | | | | | | |
| | (A) | | | | | | | |
| | Vulcanization | 0.5 | 0.5 | 0.5 | 0.5 | 0.5 | 0.5 | 0.5 |
| | accelerator | | | | | | | |
| | (B) | | | | | | | |
| Process | Degassed? | No | No | Yes | No | Yes | Yes | Yes |
| | Storage time | 30 hours | 30 hours | 30 hours | 8 hours | 8 hours | 8 hours | 8 hours |
| | Slit maximum width | 2 | 2 | 2 | 2 | 5 | 2 | 2 |
| Evaluation | Number of voids each | 23 | 20 | 19 | 22 | 17 | 2 | 0 |
| | having a volume of | | | | | | | |
| | 4.19 μm³ or more per | | | | | | | |
| | 8,000,000 μm³ | | | | | | | |
| | Air permeation coefficient | | | | | | | |
| | cm³ · cm/(cm² · s · cmHg) | 2.0 × 10⁻¹⁰ | 1.7 × 10⁻¹⁰ | 1.5 × 10⁻¹⁰ | 1.7 × 10⁻¹⁰ | 1.3 × 10⁻¹⁰ | 9.5 × 10⁻¹¹ | 9.0 × 10⁻¹¹ |
| | Air leakage (%/month) | 1.04 | 1.00 | 1.00 | 1.01 | 0.98 | 0.79 | 0.77 |

Composition units of the components in Table 1 are parts by mass.

In the inner liner or the like of a pneumatic tire, a rubber composition containing a butyl-based rubber, which is hard for air to permeate, may be used (for example, Japanese Patent Laid-Open Publication No. 2014-227494).

Such a rubber composition may be manufactured by blending a butyl-based rubber, a natural rubber, a carbon black, a filler, and the like, and using an extruder to knead and mold the mixture, and vulcanizing the molded product.

In recent years, it has been demanded to further lower gas permeability of a vulcanized rubber composition.

A pneumatic tire according to an embodiment of the present invention has excellent low gas permeability (in particular, having a property of being hard for air to permeate).

A pneumatic tire according to an embodiment of the present invention has an inner liner formed of a vulcanized rubber composition and has an excellent low gas permeability when a number of voids each having a volume of 4.19 μm³ or more per 8,000,000 μm³ in the vulcanized rubber composition in an environment of 60° C. under an atmospheric pressure is 2 or less, and an air permeation coefficient of the vulcanized rubber composition measured using a differential pressure method in an environment of 60° C. is 0.95×10⁻¹⁰ cm³·cm/(cm²·s·cmHg) or less. Further, such a vulcanized rubber composition having excellent low gas permeability can be suitably manufactured, for example, using a vulcanized rubber composition manufacturing method. A method according to an embodiment of the present invention includes a kneading process in which an unvulcanized rubber composition is subjected to kneading by extrusion molding, and a vulcanization process in which, after the kneading process, the unvulcanized rubber composition is vulcanized. In the kneading process, the unvulcanized rubber composition is degassed after passing through a slit having a maximum width of 2 mm or less provided in a screw of an extruder. In the vulcanization process, the unvulcanized rubber composition is vulcanized within 24 hours after being extrusion-molded in the kneading process.

A pneumatic tire according to an embodiment of the present invention includes an inner liner formed of a vulcanized rubber composition, in which a number of voids each having a volume of 4.19 μm³ or more per 8,000,000 μm³ in the vulcanized rubber composition in an environment of 60° C. under an atmospheric pressure is 2 or less, and an air permeation coefficient of the vulcanized rubber composition measured using a differential pressure method in an environment of 60° C. is 0.95×10⁻¹⁰ cm³·cm/(cm²·s·cmHg) or less.

In a pneumatic tire according to an embodiment of the present invention, the vulcanized rubber composition is degassed by passing through a slit having a maximum width of 2 mm or less provided in a screw of an extruder during extrusion molding of an unvulcanized rubber composition before vulcanization.

In a pneumatic tire according to an embodiment of the present invention, the vulcanized rubber composition is vulcanized within 24 hours after an unvulcanized rubber composition before vulcanization is extrusion-molded.

In a pneumatic tire according to an embodiment of the present invention, thermal history during the extrusion molding is 100° C. or higher.

In a pneumatic tire according to an embodiment of the present invention, the vulcanized rubber composition contains a carbon black, and the carbon black is dehydrated before being blended into the unvulcanized rubber composition before vulcanization.

In a pneumatic tire according to an embodiment of the present invention, a thickness of a thinnest portion is 0.2 mm or more.

A method for manufacturing a vulcanized rubber composition according to an embodiment of the present invention includes: a kneading process in which an unvulcanized rubber composition is subjected to kneading by extrusion molding; and a vulcanization process in which, after the kneading process, the unvulcanized rubber composition is vulcanized.

In the kneading process, the unvulcanized rubber composition is degassed after passing through the slit having a maximum width of 2 mm or less provided in the screw of the extruder.

In the vulcanization process, the unvulcanized rubber composition is vulcanized within 24 hours after being extrusion-molded in the kneading process.

A pneumatic tire according to an embodiment of the present invention has excellent low gas permeability.

Obviously, numerous modifications and variations of the present invention are possible in light of the above teachings. It is therefore to be understood that within the scope of the appended claims, the invention may be practiced otherwise than as specifically described herein.

What is claimed is:

1. A pneumatic tire, comprising:
an inner liner comprising a vulcanized rubber composition such that a number of voids each having a volume of 4.19 μm³ or more per 8,000,000 μm³ in the vulcanized rubber composition is 2 or less in an environment of 60° C. under an atmospheric pressure, and that the vulcanized rubber composition has an air permeation coefficient of 0.95×10⁻¹⁰ cm³·cm/(cm²·s·cmHg) or less when measured by a differential pressure method in the environment of 60° C.

2. The pneumatic tire of claim 1, wherein the vulcanized rubber composition is produced by a process comprising extrusion-molding an unvulcanized rubber composition by an extruder comprising a screw having a slit such that the unvulcanized rubber passes through the slit having a maximum width of 2 mm or less and degassed during the extrusion-molding of the unvulcanized rubber composition.

3. The pneumatic tire of claim 1, wherein the vulcanized rubber composition is produced by a process comprising vulcanizing an unvulcanized rubber composition within 24 hours after extrusion-molding of the unvulcanized rubber composition such that the vulcanized rubber composition is obtained.

4. The pneumatic tire of claim 3, wherein the process comprises extrusion-molding the unvulcanized rubber composition by an extruder comprising a screw having a slit such that the unvulcanized rubber passes through the slit having a maximum width of 2 mm or less and degassed during the extrusion-molding of the unvulcanized rubber composition and that thermal history during the extrusion-molding is 100° C. or higher.

5. The pneumatic tire of claim 1, wherein the vulcanized rubber composition comprises a carbon black dehydrated before being blended into an unvulcanized rubber composition before vulcanization.

6. The pneumatic tire of claim 1, wherein the inner liner has a thinnest portion having a thickness of 0.2 mm or more.

7. The pneumatic tire of claim 2, wherein the process comprises vulcanizing the unvulcanized rubber composition within 24 hours after the extrusion-molding of the unvulcanized rubber composition such that the vulcanized rubber composition is obtained.

8. The pneumatic tire of claim 7, wherein thermal history during the extrusion-molding of the unvulcanized rubber composition is 100° C. or higher.

9. The pneumatic tire of claim 2, wherein the vulcanized rubber composition comprises a carbon black dehydrated before being blended into the unvulcanized rubber composition before vulcanization.

10. The pneumatic tire of claim 2, wherein the inner liner has a thinnest portion having a thickness of 0.2 mm or more.

11. The pneumatic tire of claim 3, wherein the vulcanized rubber composition comprises a carbon black dehydrated before being blended into the unvulcanized rubber composition before vulcanization.

12. The pneumatic tire of claim 3, wherein the inner liner has a thinnest portion having a thickness of 0.2 mm or more.

13. The pneumatic tire of claim 4, wherein the vulcanized rubber composition comprises a carbon black dehydrated before being blended into the unvulcanized rubber composition before vulcanization.

14. The pneumatic tire of claim 4, wherein the inner liner has a thinnest portion having a thickness of 0.2 mm or more.

15. The pneumatic tire of claim 5, wherein the inner liner has a thinnest portion having a thickness of 0.2 mm or more.

16. A method for manufacturing a vulcanized rubber composition, comprising:
extrusion-molding an unvulcanized rubber composition by an extruder comprising a screw having a slit such that the unvulcanized rubber passes through the slit having a maximum width of 2 mm or less and degassed during the extrusion-molding of the unvulcanized rubber composition; and
vulcanizing the unvulcanized rubber composition within 24 hours after the extrusion-molding of the unvulcanized rubber composition such that a vulcanized rubber composition is obtained,
wherein a number of voids each having a volume of 4.19 μm³ or more per 8,000,000 μm³ in the vulcanized rubber composition is 2 or less in an environment of 60° C. under an atmospheric pressure, and the vulcanized rubber composition has an air permeation coefficient of 0.95×10⁻¹⁰ cm³·cm/(cm²·s·cmHg) or less when measured by a differential pressure method in the environment of 60° C.

17. The method of claim 16, wherein thermal history during the extrusion-molding of the unvulcanized rubber composition is 100° C. or higher.

18. The method of claim 16, further comprising:
blending, into the unvulcanized rubber composition, a carbon black dehydrated before being blended into the unvulcanized rubber composition.

19. The method of claim 16, wherein the vulcanized rubber composition has a thinnest portion having a thickness of 0.2 mm or more.

20. The method of claim 17, further comprising:
blending, into the unvulcanized rubber composition, a carbon black dehydrated before being blended into the unvulcanized rubber composition.
